(19) United States
(12) Patent Application Publication
(10) Pub. No.: US 2011/0050621 A1
(43) Pub. Date: Mar. 3, 2011

(54) RESISTIVE TOUCH PANEL

(76) Inventor: Jane HSU, Taoyuan County (TW)

(21) Appl. No.: 12/611,587

(22) Filed: Nov. 3, 2009

(30) Foreign Application Priority Data
Aug. 27, 2009 (TW) 098215800

(51) Int. Cl. G06F 3/045

(52) U.S. Cl. 345/174; 178/18.01

(57) ABSTRACT

A resistive touch panel has a lower panel module, an upper panel module and a flexible circuit board. The upper panel module has a protective film sequentially printed with a pattern layer and a varnish layer on a top thereof, an upper conducting layer mounted on a bottom of the protective film, an upper electrode mounted on a perimeter on a bottom of the upper conducting layer, an insulation layer mounted on edges of the bottom of the upper conducting layer, covered on the upper electrode and bonded to a top of the lower panel module, and an conductive adhesive mounted on the insulation layer to contact with the upper electrode. Given the foregoing structure, due to the elimination of the solid film and the adhesive layer, defects generated when using the adhesive layer to bond the solid film and the protective film are avoided for improved productivity.

### BACKGROUND OF THE INVENTION

1. Field of the Invention

The present invention relates to a resistive touch panel, and more particularly to a resistive touch panel having an upper panel module free of solid film.

2. Description of Related Art

Categorized by the technical concepts, touch panels can be divided into capacitive touch panels, resistive touch panels, surface acoustic wave touch panels, infrared touch panels and the like, among which the resistive touch panels have the largest market share due to the advantages of light weight, inexpensive price and higher degree of technical maturity.

With reference to FIGS. 3 and 4, a conventional resistive touch panel has an upper panel module (A′), a lower panel module (B′) and a flexible circuit board (C′).

The upper panel module (B′) has a transparent substrate (20), a lower conducting layer (21), a plurality of lower electrodes (211), a separating layer (22) and a first adhesive layer (23).

The lower conducting layer (21) is mounted on a top surface of the transparent substrate (20). The plurality of lower electrodes (211) are mounted on edges of a top surface of the lower conducting layer (21). The separating layer (22) and the first adhesive layer (23) are mounted on the top surface of the lower conducting layer (21). The first adhesive layer (23) surrounds a perimeter of the separating layer (22) and is covered on the lower electrodes (211). A plurality of conductive adhesives (231) are formed on the first adhesive layer (23) to respectively contact with the lower electrodes (231).

The upper panel module (A′) has a solid film (24), a pattern layer (25), a protective film (26), a second adhesive layer (27), an upper conducting layer (28), an upper electrode (281) and an insulation layer (29).

The pattern layer (25) is printed on a bottom surface of the solid film (24). The protective film (26) is bonded to a bottom surface of the solid film (24) through the second adhesive layer (27) and covered on the pattern layer (25). The upper conducting layer (28) is mounted on a bottom surface of the protective film (26). The upper electrode (281) is mounted on edges of a bottom surface of the upper conducting layer (28). The insulation layer (29) is mounted on a perimeter of a bottom surface of the upper conducting layer (28) and bonded to a top surface of the first adhesive layer (23) of the lower panel module (B′). A conductive adhesive (291) is mounted on the insulation layer (29) to contact with the upper electrode (281).

The flexible circuit board (C′) is mounted between the first adhesive layer (23) and the insulation layer (29) and has a plurality of terminals (C1′) respectively contacted with the conductive adhesives (231, 291) of the first adhesive layer (23) and of the insulation layer (29) to electronically connect with the lower electrodes (211) and the upper electrode (281).

The pattern layer (25) is printed on the bottom surface of the solid film (24) to delimit certain regions on the touch panel allowing users to press those regions and initiate designated operations. After the pattern layer (25) is printed, the solid film (24) and the protective film (26) are tightly bonded by means of the second adhesive layer (27). However, upon bonding, air between the solid film (24) and the protective film must be completely evacuated. Otherwise, unevenness is formed on the screen of the resistive touch panel, further impacting the operational effectiveness of the touch panel. The resulting touch panel is defective since air left between the solid film (24) and the protective film (26) so adding to manufacturing costs. Accordingly, the conventional resistive touch panel needs to be further refined.

### SUMMARY OF THE INVENTION

The main objective of the present invention is to provide a resistive touch panel, disposes of a need of mounting of a solid film during fabrication and fully eliminates defects arising from air left between the solid film and a protective film during a bonding process of a conventional resistive touch panel so as to raise yields.

To achieve the foregoing objective, the aforementioned resistive touch panel has a lower panel module, an upper panel module and a flexible circuit board.

The lower panel module has a transparent substrate, a lower conducting layer, a plurality of lower electrodes, a separating layer, an adhesive layer, and a plurality of lower conductive adhesives.

The transparent substrate has a top surface. The lower conducting layer is formed on the top surface of the substrate and having a top surface. A plurality of lower electrodes are mounted on edges of the top surface of the lower conducting layer. A separating layer is mounted on the top surface of the lower conducting layer and has a perimeter. The adhesive layer has a top surface, is mounted on the top surface of the lower conducting layer, and surrounds the perimeter of the separating layer. The plurality of lower conductive adhesives are respectively contacted with the plurality of lower electrodes.

The upper panel module has a protective film, an upper conducting layer, an upper electrode, an insulation layer and an upper conductive adhesive.

In contrast to the conventional resistive touch panel, the present invention has the pattern layer directly printed on the top surface of the protective film. Accordingly, the solid film and the adhesive layer for bonding the solid film and the protective film can be eliminated. Therefore, the present invention does not suffer from air being left between the solid film and the protective film in the fabrication process of the conventional resistive touch panel so quantity of defects is reduced, thereby achieving cost reductions.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a resistive touch panel in accordance with the present invention;

FIG. 2 is a partial cross-sectional view of FIG. 1;

FIG. 3 is an exploded perspective view of a conventional resistive touch panel in accordance with prior art; and

FIG. 4 is a partial cross-sectional view of FIG. 3.

### DETAILED DESCRIPTION OF THE EMBODIMENT

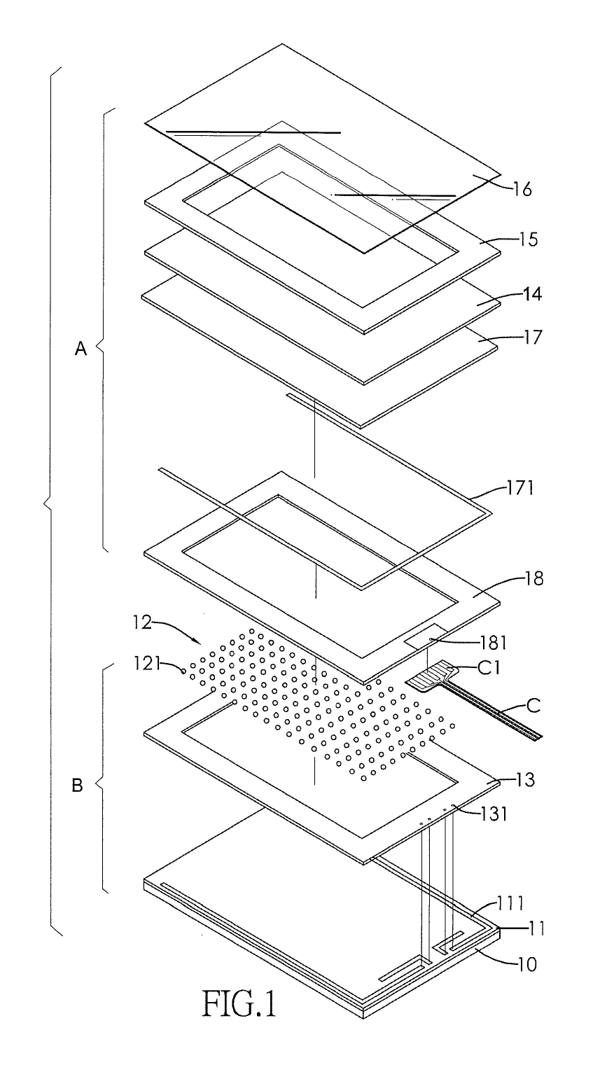

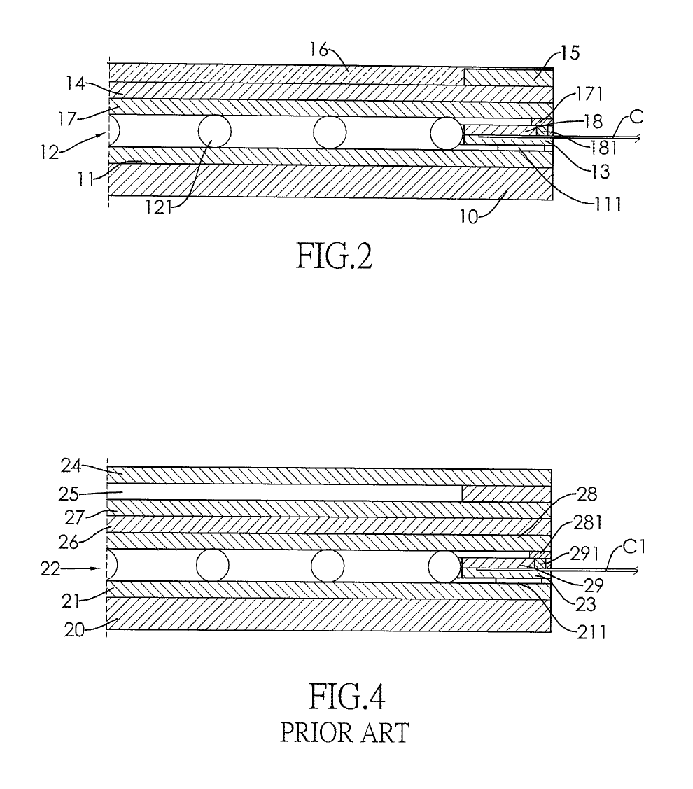

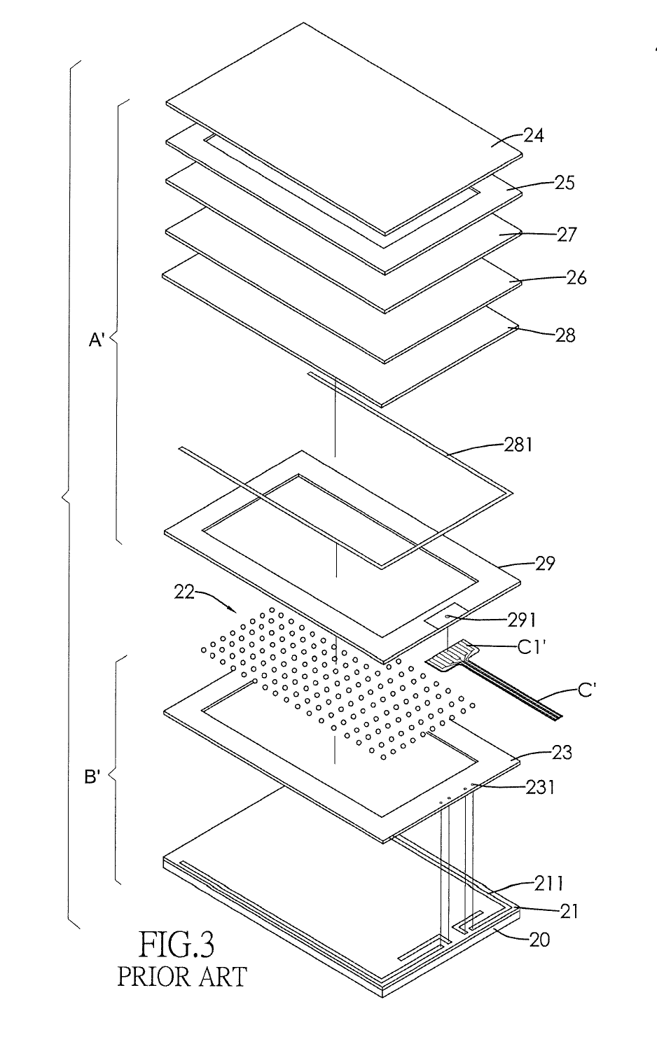

With reference to FIG. 1 and FIG. 2, a resistive touch panel in accordance with the present invention has an upper panel module, a lower panel module and a flexible circuit board (C).

The lower panel module (B) is the same as the conventional resistive touch panel and has a transparent substrate (10), a lower conducting layer (11), a separating layer (12) and an adhesive layer (13).

The transparent substrate (10) may be a glass board.

The lower conducting layer (11) is mounted on a top surface of the transparent substrate (10). A plurality of lower electrodes (111) are mounted on edges of a top surface of the lower conducting layer (11). The lower electrodes (111) may be silver electrodes printed by silver paste.

The separating layer (12) takes the form of a plurality of rows of separating grains and is mounted on a top surface of the lower conducting layer (11).

The adhesive layer (13) is mounted on the top surface of the lower conducting layer (11), surrounds a perimeter of the separating layer (12) and is covered on the lower electrodes (111). A plurality of lower conductive adhesives (131) are mounted on the adhesive layer (13) to respectively contact with the lower electrodes (111).

The upper panel module (A) has a protective film (14), an upper conducting layer (17) and an insulation layer (18).

The protective film (14) has a pattern layer (15) and a varnish layer (16) sequentially printed on a top surface. The varnish layer (16) is covered on the pattern layer (15) and renders the surface of the touch panel glossy.

The upper conducting layer (17) is mounted on a bottom surface of the protective film (14). An upper electrode (171) is mounted on edges of a bottom surface of the upper conducting layer (17). The upper electrode (171) may be a silver electrode printed by silver paste.

The insulation layer (18) is mounted on edges of the bottom surface of the upper conducting layer (17) and is covered on the upper electrode (171). An upper conductive adhesive (181) is mounted on the insulation layer (18) to contact with the upper electrode (171).

The flexible circuit board (C) has a plurality of terminals (C1).

The aforementioned upper panel module (A), lower panel module (B) and flexible circuit board (C) are mutually lapped to form the resistive touch panel of the present invention. The insulation layer (18) of the upper panel module (A) is bonded to a top surface of the adhesive layer (13) of the lower panel module (B). The flexible circuit board is sandwiched by the adhesive layer (13) and the insulation layer (18). The terminals (C1) of the flexible circuit board (C) respectively contact with the lower conductive adhesives (131) of the adhesive layer (13) and the upper conductive adhesives (181) of the insulation layer (18) so as to electronically connect with the lower electrode (111) and the upper electrode (171).

When exerting a force on the varnish layer (16) of the upper panel module (A), the upper conducting layer is pressed down to contact with the lower conducting layer (11) in generation of a short-circuit and a voltage drop. The voltage drop signal is transmitted to the flexible circuit board (C) through the upper electrode (171), the lower electrode (111), the upper conductive adhesive (181) and the lower conductive adhesives (131), and is outputted from the flexible circuit board (C) such that the coordinates of the contact point on the touch panel can be calculated.

In contrast to the conventional resistive touch panel, the upper panel module (A) of the present invention removes the solid film. As such, defects arising from loosely bonding the solid film and the protective film by means of the adhesive layer are no longer an issue. Moreover, overall cost due to the elimination of the solid film and the adhesive layer is further reduced, and the entire thickness of the final product is thinner.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A resistive touch panel, comprising:
a lower panel module comprising:
a transparent substrate having a top surface;
a lower conducting layer formed on the top surface of the substrate and having a top surface;
a plurality of lower electrodes mounted on edges of the top surface of the lower conducting layer;
a separating layer mounted on the top surface of the lower conducting layer and having a perimeter;
an adhesive layer having a top surface, mounted on the top surface of the lower conducting layer, and surrounding the perimeter of the separating layer; and
a plurality of lower conductive adhesives respectively contacted with the plurality of lower electrodes;
an upper panel module, comprising:
a protective film having a top and a bottom surfaces and having a pattern layer and a varnish layer sequentially printed on the top surface thereof;
an upper conducting layer having a bottom surface and mounted on the bottom surface of the protective film;
an upper electrode mounted on edges of the bottom surface on the upper conducting layer; and
an insulation layer having a top surface, mounted on edges of the bottom surface of the upper conducting layer, covered on the upper electrode, and bonded to the top surface of the adhesive layer of the lower panel module; and
an upper conductive adhesive mounted on the top surface of the insulation layer to contact with the upper electrode; and
a flexible circuit board mounted between the adhesive layer and the insulation layer, and having a plurality of terminals respectively contacted with the corresponding lower conductive adhesives on the adhesive layer and the upper conductive adhesive on the insulation layer.

2. The resistive touch panel as claimed in claim 1, wherein the transparent substrate is a glass board.

3. The resistive touch panel as claimed in claim 1, wherein the upper electrode is a silver electrode.

4. The resistive touch panel as claimed in claim 2, wherein the upper electrode is a silver electrode.

5. The resistive touch panel as claimed in claim 1, wherein each of the lower electrodes is a silver electrode.

6. The resistive touch panel as claimed in claim 2, wherein each of the lower electrodes is a silver electrode.

7. The resistive touch panel as claimed in claim 1, wherein the upper electrode and each of the lower electrodes are silver electrodes.

8. The resistive touch panel as claimed in claim 2, wherein the upper electrode and each of the lower electrodes are silver electrodes.
